(19) United States
(12) Patent Application Publication
(10) Pub. No.: US 2012/0138679 A1
(43) Pub. Date: Jun. 7, 2012

(54) Secure two dimensional bar codes for authentication

(75) Inventor: Brian Joseph Doyle, Victoria (CA)

(73) Assignee: YODO INC., Victoria (CA)

(21) Appl. No.: 13/309,133

(22) Filed: Dec. 1, 2011

Related U.S. Application Data
(60) Provisional application No. 61/418,415, filed on Dec. 1, 2010.

(51) Int. Cl. G06K 5/00; G06K 19/06

(52) U.S. Cl. 235/380; 235/494

(57) ABSTRACT

The invention is a method for creating one time-use highly secure 2D barcodes, or secure two-dimensional barcodes, by utilizing machine readable physical tokens such as read only memory (ROM) or biometric data as a precursor and then applying a public key encryption algorithm and a time-stamp to otherwise standard 2D barcode generation schemas.

### BACKGROUND

2D or two-dimensional barcodes such as Quick Response (QR) codes©, which were developed by Denso Wave and Tags© developed by Micro Soft have found wide spread use in commercial advertising where mobile phone cameras may be used to scan the codes and thus read or discover the data required to direct the mobile device's software browser application to specific internet address (URL) and/or the code can also be printed as machine readable identity marks, or product codes for any number of non-secure product identification tags. QR codes have been standardized in ISO/IEC 18004:2006 QR Code 2005 specification

Unfortunately 2D or two-dimensional barcodes are easily reproduced, allowing hundreds of copies to be reproduced from a single copy by machine methods such as photo copying. This has limited the practical use of two-dimensional codes in applications requiring high speed creation of machine readable secure identity tokens, for example in mobile monetary transactions, for which the invention is a proposed solution. The advent of powerful multi-core microprocessors on mobile devices has made it practical for machine readable physical identity tokens to be captured and directly incorporated into two-dimensional bar codes for secure authentication purposes.

### PRIOR ART

Two dimensional bar codes have seen extensive use in a number of commercial applications from Starbuck's Coffee company's use of QR codes as a replacement for pre-paid cards allowing customers to display a QR code on their mobile phone screen as an easily captured electronic form of their pre-paid purchase card to a number of airlines using QR codes to encode passenger boarding information onto boarding passes. These prior usages have represented a “static” use of two-dimensional codes to allow the quick and efficient capture of encoded data such as the customers' card account number or passengers' name, seat number and airline flight number, and have thus failed to offer a highly secure method for authentication being reliant upon secondary physical tokens, the passenger's passport or the actual pre-paid card itself, for security purposes. Two-dimensional bar codes have thus far been useful therefore to represent sensitive and legal, account or personal data only in so much as they are more conveniently printed or captured than other conventional machine readable technologies.

Efforts have been made to render post generated two-dimensional codes more secure and tamper resistant by using various apparatuses such as special proprietary scanners to read the displayed codes or by the use of additional features such as geometric marks on otherwise standard two dimensional codes. Brett US patent application #20110233284 for example discloses a method to use geometric colored marks to overlay a security element on a standard QR code.

Parikh (US application #20110137742 assigned to E-Bay Inc.), describes using captured two-dimensional product bar-codes on a mobile device to specify a consumer's purchase choice and facilitate payment transactions. The application claims the inclusion of some customer account information without providing any details. Parikh's application nevertheless fails to claim use of machine-readable physical identity token(s) incorporated into the QR code to enhance the security of the codes, nor does it satisfy another of the objectives of the present applicant's invention, being to utilize highly secure tamper proof biometric data for authentication purposes while at the same time protecting the personal privacy of the individual by incorporating it into a secure two-dimensional code (or in simple terms using a person's facial image captured on a digital camera for authentication purposes for internet commerce while never actually exposing said facial image). Kasper et al., US application #2009183247 claims the use of multi factor encryption plus biometrics to control access to a network but makes no reference to transforming such identity information into a two-dimensional bar code.

### DETAILED DESCRIPTION

Preferred embodiment of the invention is a two-dimensional barcode, for example such as a security enhanced QR code, generated by the capture of, or use of precursor machine readable identity token(s) to which are applied a public key encryption algorithm before said codes are displayed on a high resolution display such as is found on a mobile telephone or other hand held electronic device. Each two-dimensional bar code so generated even when using the same physical precursor token(s) may be unique and used only once by the inclusion of a time stamp and/or random specific transaction information such as the retail location or amount of transaction.

References are made herein to SKS Codes which is nomenclature for the form of secure QR code proposed by the applicant; however the invention is equally applicable to, and could be used to create secure one-time-use two dimensional barcodes from, or based on, any other known two-dimensional bar code schema such as for example DataMatrix codes.

Typically a mobile phone may be used to both capture the precursor identity token(s) and display the generated secure two-dimensional bar codes. The mobile device should preferably be connected to the world-wide-web or internet and have both a digital camera and a digital display. Said digital camera may be used to capture biometric tokens of the person using the device, such as a facial recognition pattern and SKS codes generated and displayed on other devices. Tamper resistant read only memory (ROM) in a removal card format such as a micro-secure-digital (μSD) card or subscriber-identity-module, (SIM) card may serve as precursor identity tokens.

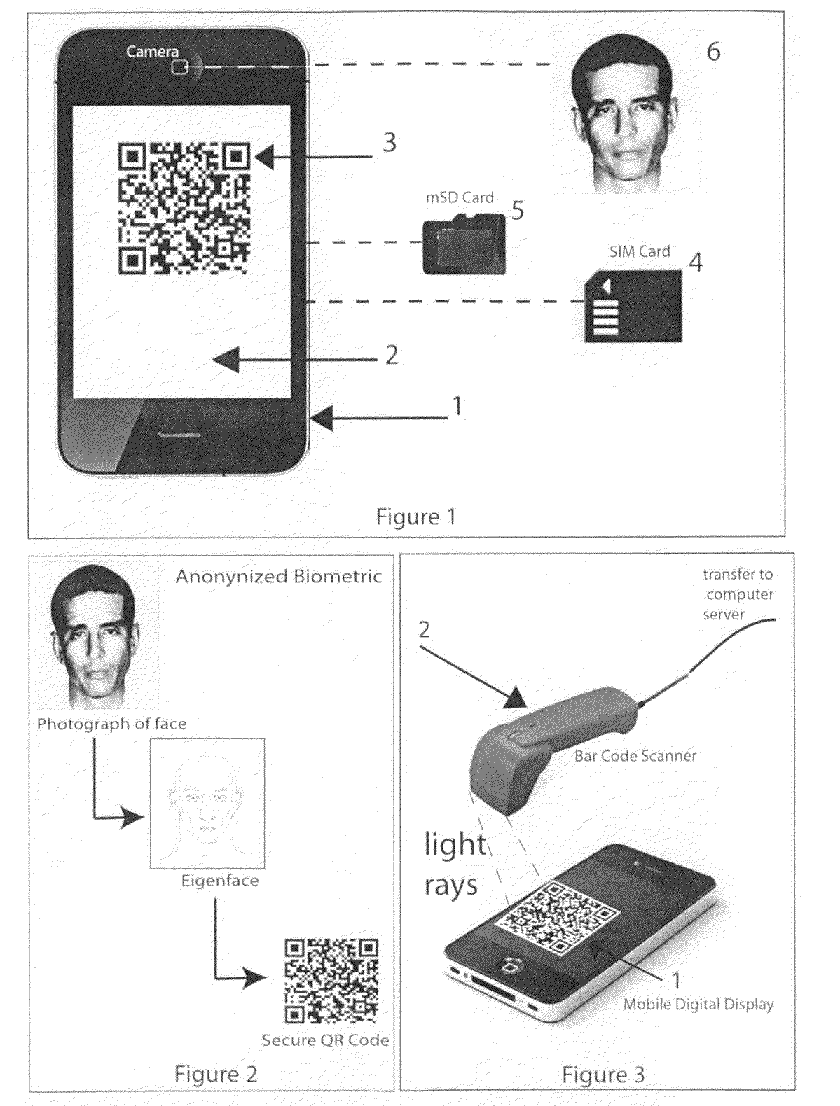

FIG. 1 shows a Cellular, or mobile telephone (1) with a liquid crystal display (LCD) (2) or organic light emitting diodes display (OLED) or equivalent electronic display capable of displaying a high resolution machine readable two-dimensional bar code as shown (3). The 2D code shown represents a SKS code generated by first using the computer hardware and software resources of the mobile phone or digital device to capture machine readable unique identity token(s) such as the card identity number (CID) from an inserted microSD (5) or SIM card (4) or a biometric token of the person using the phone (6), then using software running on the device's microprocessor to add a time-stamp using the current GMT time downloaded from the internet over the mobile radio network to which the mobile handset or digital device communicates, forming a concatenation or aggregate of the digitized unique identity token(s) and the time stamp (GMT), encrypting the resulting digital code by using a mathematical encryption algorithm such as public key encryption (PKI) where the public key is stored in the mobile application or a symmetrical encryption algorithm such as the Tiny Encryption Algorithm (TEA) or equivalent and then using the standard QR encoding algorithm to create and display the secure SKS code on the digital screen.

FIG. 2 shows graphically the method of applying Principal Component Analysis (PCA) and bit-width-reduction methods to map high dimensional facial recognition data into a low dimensional space to save memory, computation and communication time and to also anonymise the data thus protecting a person's privacy. Research by Yongsoon Lee has demonstrated over 94% retention of accuracy for authentication purposes using bit-width-reduction methods and following a 50% reduction in bit-width from 32 bits to 16 bits.

FIG. 3 shows the preferred method for utilizing the code, where the mobile phone or digital device (1) is placed in proximity to a two dimensional barcode scanner (2) which scans the visible SKS Code to obtain the encrypted digital code and sends said captured code via wired or wireless communications to a computer server possessing the private encryption key and thus able to decode and ascertain or authenticate the originally captured physical identity token(s). Since the SKS has been time stamped with the exact time it was generated, all SKS codes generated are time-synchronized on a global basis, and the server can reject as expired or “stale-dated” any code following some pre-determined lapse of time, for example 3 minutes. In the case where SKS codes are routed via the internet to computer servers for a transaction purpose, such as linking to an online payment account, a loop back mechanism can be utilized to cause the mobile phone application or digital device's software to again capture and thus ascertain that the correct physical identity precursor token remains present as added security prior to authorizing or completing any transaction.

Replacements for, or alternate forms of precursor identity tokens, other than biometric data of the person using the device or the microSD card and the SIM card could be NFC chip identity codes and/or the international mobile equipment identity (IMEI) codes present on all mobile devices. Biometric precursor identity tokens could be captured not only by the digital camera present on a mobile phone but also from additional sensors such as a finger print capture device or via the microphone in the form of a user's voice recognition pattern (datum). In the case of using a person's facial scan as the biometric precursor identity token to create the two dimensional secure bar code, Principal Component Analysis (PCA) can be used to both increase the efficiency of the invention by reducing the data space to an isometric invariant signature or Eigenface, and also to provide privacy protection. The strength of the security and the process for creating the codes remains intact and in the case of biometric tokens or IMEI codes the ubiquity of the precursor token(s) only increases. Most CCD-digital cameras such as those in mobile handset and even inexpensive web cameras can in addition to capturing the biometric precursor token(s) also read, or capture, generated SKS codes for subsequent decoding.

1) A method for creating a secure two-dimensional bar code by capturing and utilizing any number of different physical machine-readable precursor tokens, for example unique read only memory (ROM) or biometric datum, and applying an encryption algorithm such as PKI to generate otherwise normal two-dimensional bar codes on a one-time basis

2) A method of claim 1, for time-stamping in a globally synchronized fashion all secure two dimensional codes to allow discriminate use of the code, in accepting or rejecting them for authentication purposes, dependent upon expiry time.

3) A method of claim 1, to Anonymise easily captured and highly recognizable biometrics identifiers, such as the digital image of a person's face, to protect the personal privacy of individuals when such a biometrics is to be used as a precursor authentication token.

4) A method for authenticating mobile device users by reading or capturing with normal bar code scanners and/or digital cameras unique identity token(s) datum which have been encrypted and incorporated into visibly displayed otherwise normal two-dimensional bar codes and communicating the captured datum to computer servers over the internet which are able to decrypt and verify said unique identity token(s) datum thus enabling said two-dimensional codes to be used for authentication purposes in electronic commerce.
